(19) United States
(12) Patent Application Publication
(10) Pub. No.: US 2007/0137172 A1
(43) Pub. Date: Jun. 21, 2007

(54) Geometric configuration and confinement for deflagration to detonation transition enhancement

(75) Inventors: Adam Rasheed, Glenville, NY (US); Anthony John Dean, Scotia, NY (US); Venkat Eswarlu Tangirala, Niskayuna, NY (US); David Michael Chapin, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/304,889

(22) Filed: Dec. 16, 2005

(51) Int. Cl. F02C 5/00

(52) U.S. Cl. 60/39.76; 60/39.821

(57) ABSTRACT

A pulse detonation combustor is provided with a fuel-air mixer located upstream from a detonation chamber. A fuel-air mixture exits the fuel-air mixer and enters the detonation chamber, where it is ignited by an ignition source. The flow from the fuel-air mixer passes over the surface of a center body, which extends downstream from the fuel-air mixer. The surface of the center body contains at least one turbulence generator, which imparts additional turbulence in the fuel-air mixture passing through the chamber. The turbulence generator aids in the mixing of the fuel and air of the fuel-air mixture to enhance the deflagration to detonation transition within the pulse detonation combustor.

### BACKGROUND OF THE INVENTION

This invention relates to an apparatus and method for enhancing mixing of a fuel-air mixture in a pulse detonation combustor to reduce the overall run-up time and/or distance to detonation of the mixture.

In pulse detonation combustors, a mixture of fuel and air is ignited and is transitioned from deflagration to detonation, so as to produce supersonic shock waves, which can be used to provide thrust, among other functions. This deflagration to detonation transition (DDT) typically occurs in a smooth walled tube or pipe structure, having an open end through which the exhaust exits.

The deflagration to detonation process begins when a fuel-air mixture in a tube is ignited via a spark or other source. The subsonic flame generated from the spark accelerates as it travels along the length of the tube due to various chemical and flow mechanics. As the flame reaches sonic velocity, shocks are formed which reflect and focus creating “hot spots” and localized explosions, eventually transitioning the flame to a super sonic detonation wave.

As indicated previously, the above described process takes place along the length of a tube, and is often referred to as the run-up to detonation., i.e. the distance/time from spark to detonation.

However, a problem with existing smooth walled tube structures is the relative long run-up length necessary to achieve detonation of the fuel-air mixture. In fact, in many applications the run-up length, up to detonation, can be such that the ratio L/D (i.e. tube length over tube diameter) is greater than 100. This run-up length is problematic when trying to incorporate the pulse detonation combustor in applications where space and weight are important factors, such as aircraft engines.

Efforts have been made to reduce the run-up length to detonation by using obstacles within the flow, in an effort to enhance mixing of the fuel-air mixture. However, there still exists a need to reduce the run-up length and accelerate the development of the flame kernel around the spark or ignition source.

### SUMMARY OF THE INVENTION

In an embodiment of the present invention, a turbulence generator is positioned upstream of the spark region to aid in the mixing of the fuel-air mixture and a shaped center body is positioned within the tube to further enhance mixing and accelerate the stretching of the flame, so as to reduce the run-up length to detonation. Specifically, the present invention employs at least one fuel-air mixer located upstream of the ignition source which imparts turbulence into the mixture, which enhances mixing. Further, at least one shaped center body is placed within the flow path of the fuel-air mixture to further enhance the mixing. The shaped center body is configured such that it imparts additional turbulence into the flow.

In an embodiment of the present invention, the shaped center-body contains a number of recessions, dimples or protrusions which further interact with the flow, thus imparting additional turbulence in the flow, thus reducing the overall run-up length.

By adjusting various parameters, such as the shape, size, and surface contour of the center body, the positioning and shape of the fuel-air mixer, and the positioning of the spark or ignition source, the present invention reduces the DDT run-up length and run-up time in a pulse detonation combustor, allowing for the construction of more compact and practical PDC.

As used herein, a “pulse detonation combustor” (“PDC”) is understood to mean any combustion device or system where a series of repeating detonations or quasi-detonations within the combustor cause a pressure rise and subsequent acceleration of the combustion products as compared to the pre-burned reactants. A “quasi-detonation” is a combustion process that produces a pressure rise and velocity increase higher than the pressure rise produced by a deflagration wave. Typical embodiments of PDCs include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge, laser pulse, or plasma pulse or by gas dynamic processes, such as shock focusing, autoignition or by another detonation via cross-firing. The geometry of the detonation chamber is such that the pressure rise of the detonation wave expels combustion products out the PDC exhaust to produce a high-velocity or supersonic jet stream. As known to those skilled in the art, pulse detonation may be accomplished in a number of types of detonation chambers, including detonation tubes, shock tubes, resonating detonation cavities and annular detonation chambers.

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 is a diagrammatical representation of a pulse detonation combustor according to an embodiment of the present invention;

FIG. 2 is a diagrammatical representation of a pulse detonation combustor according to another embodiment of the present invention;

FIG. 3 is a diagrammatical representation of a pulse detonation combustor according to an alternative embodiment of the present invention;

FIG. 4 is a diagrammatical representation of an aft portion of a pulse detonation combustor according to a further embodiment of the present invention;

FIG. 5 is a diagrammatical representation of an aft portion of a pulse detonation combustor according to a further alternative embodiment of the present invention;

FIG. 6 is a diagrammatical representation of a pulse detonation combustor according to another alternative embodiment of the present invention; and

FIG. 7 is a diagrammatical representation of a pulse detonation combustor according to an additional alternative embodiment of the present invention.

### DETAILED DESCRIPTION OF THE INVENTION

The present invention will be explained in further detail by making reference to the accompanying drawings, which do not limit the scope of the invention in any way.

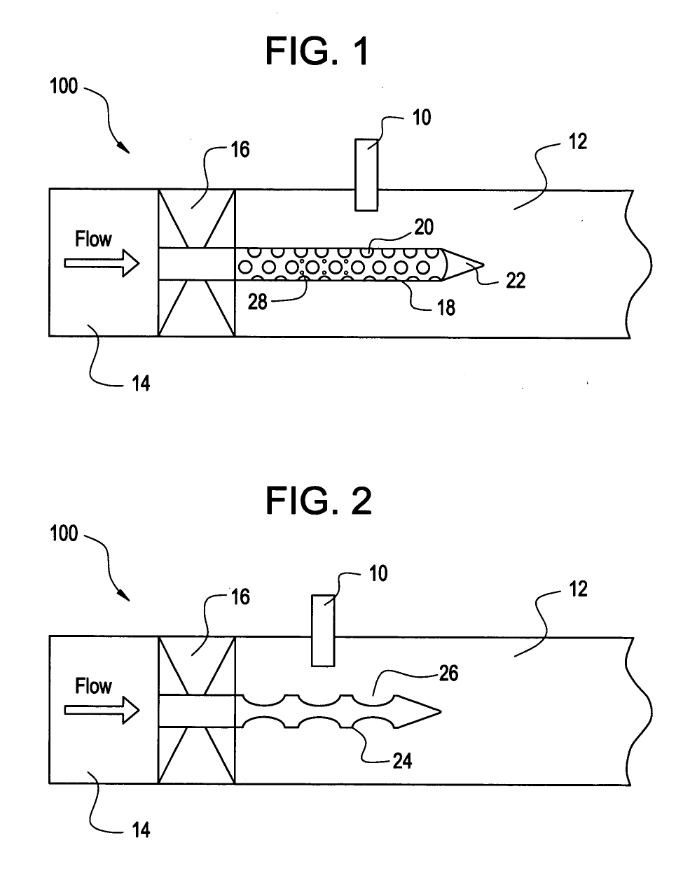

FIGS. 1 through 6 depict a cross-sectional side view of a pulse detonation combustor 100 according to various embodiments of the present invention. The pulse detonation combustors 100 contain a forward flow section 14 positioned upstream of a fuel-air mixer 16, which is, in turn, positioned upstream of an ignition source 10, a detonation chamber 12, and a center body 18 (FIG. 1). Each of the FIGS. 1 through 6 depict an alternative embodiment of the present invention, in which the center body is show with various alternative configurations.

Turning now to FIG. 1, an exemplary embodiment of the present invention is shown. In this embodiment, the pulse detonation combustor 100 contains a forward flow section 14 positioned upstream of a fuel-air mixer 16, which is, in turn, positioned upstream of an ignition source 10, a detonation chamber 12, and a center body 18. Air flow is passed through the forward flow section 14 into the fuel-air mixer 16, in which fuel is mixed with the air flow. After mixing, the fuel-air mixture passes into the detonation chamber 12, where it is ignited by the ignition source 10.

In an embodiment of the present invention, the fuel-air mixer 16 is configured with turbulence generators, swirl vanes, or similar structure (not shown) which adds to the turbulent nature of the mixture exiting the mixer 16, to further enhance the mixing of the fuel-air mixture. It is noted that the specific configuration and structure of the turbulence generators in the mixer 16 are to be configured so as to optimize the mixing of the fuel-air mixture as it enters the chamber 12.

In an additional embodiment, the flow from the forward flow section 14 can already be a mixture of fuel and air. In this embodiment, additional fuel may be added in the mixer 16, or the mixer 16 may simply act to further mix the fuel air mixture from the forward section 14 and not add additional fuel.

Extending from a central portion of mixer 16 is a shaped center body 18. As shown the center body 18 extends from the mixer 16 to a point past the ignition source 10. The overall length and diameter of the center body 18 is determined based on operational parameters and characteristics, to optimize performance. In one embodiment of the present invention, the overall cross-sectional shape of the center body 18 is circular, as shown in FIG. 1. However, the present invention is not limited to this, as the cross-sectional shape can be additional shapes, such as octahedral, polygonal, etc. The overall shape of the center body 18 is determined to optimize performance and minimize DDT run-up.

The location of the ignition source 10 along the length of the center body 18 is optimized so as to provide the shortest run-up distance and most efficient operation of the combustor 100. In one embodiment of the present invention, the ignition source 10 is positioned 2D downstream of the aft face of the mixer 16, where “D” is the inner diameter of the detonation chamber 12. In another embodiment, the ignition source 10 is positioned at the mid-point along the length of the center body 18. Although only one ignition source 10 is shown in the FIG. 1 embodiment, the present invention is not limited to this, and in alternative embodiments more than one ignition sources may be used.

As shown in FIG. 1, and the remaining figures, the ignition source 10 is shown coupled to the wall of the chamber 12. However, in an alternative embodiment the ignition source 10 is coupled to the center body 18. In a further embodiment, at least one ignition source is coupled to the wall of the chamber 12, and at least one other ignition source 10 is coupled to the center body 18.

As shown in FIG. 1, positioned along a length of center body 18 are a plurality of turbulence generators 20. These generators 20 create further turbulence and mixing of the fuel-air mixture as it passes along the chamber 12. As discussed above, this further mixing aids in accelerating the flame during deflagration, in order to more quickly achieve detonations. The shorter run-up distance/time allows for the pulse detonation combustor 100 to be made shorter, and also allow for higher operational frequencies of the combustor 100.

Positioned at the end of the center body 18 is an end portion 22. The end portion 22 is shaped so as to prevent flame holding within the chamber. The shape of the end portion 22 is to be optimized so as to prevent flame holding and permit the optimal performance of the device. In another embodiment, the end portion 22 is not used, or the shape may be changed as required to achieve the desired operational characteristics.

As shown in FIG. 1, the generators 20 are concave dimple structures in the surface of the center body 18. These dimples provide a similar effect to dimples used on a golf ball, where the dimples create a turbulent flow over the surface of the center body 18. As shown, the dimples are spherical in shape. However, the present invention is not limited to this configuration. Namely, the specific shape, depth, diameter, number and geometric configuration of the generators 20 are to be optimized so as to impart the maximum amount of mixing without inhibiting or otherwise adversely affecting the downstream flow of the fuel-air mixture or DDT.

In a further embodiment, the generators 20 are not concave (i.e. recessed with respect to the outer surface of the center body 18), but are convex and thus extending into the flow of the fuel-air mixture. Again, the geometric characteristics of the generators 20 are selected to optimize performance.

In the embodiment shown in FIG. 1, the generators 20 are distributed symmetrically along the length and around the center body 18. However, the present invention is not limited to this configuration as the generators 20 may be distributed asymmetrical to optimize performance due to the interaction with the ignition source 10. Further, in an additional embodiment, the generators 20 are divided into a number of different types of generators which have different geometric properties. Thus, the center body 18 may contain two different types of generators, where the first type of generator 20 has at least one physical property (i.e. depth, shape, diameter, height, etc.) which is different from a second type of generators 20. For example, a center body 18 may contain three different types of turbulence generators 20, where the first type has a first diameter and depth, the second type has a second diameter and depth, and the third type has a third diameter and depth. Such a configuration may be used to accelerate the mixture in one area of the chamber faster than another portion.

In a further embodiment, the center body 18 is configured with a manifold type structure within the center body 18 to permit the circulation of air/liquid/fuel to allow for cooling of the center-body 18.

In an additional embodiment, the center body 18 is further equipped with a plurality of nozzles 28 which inject additional fuel, air and/or a fuel-air mixture into the chamber 12 to further enhance the performance of the combustor 100, or the DDT process. In an alternative embodiment, the nozzles are used to inject air into the chamber during a purge phase of operation. This air assists in purging the chamber 12 between detonations. Additionally, the air can be injected at a temperature to provide a cooling effect to the surfaces of the chamber 12, ignition source 10 and center body 18. In one embodiment, a nozzle is positioned at the end of the end portion 22 to inject air to aid in the purge process.

In another embodiment, fuel is injected through the nozzles 28 into the chamber, such that the fuel acts as a coolant to the center body 18, allowing heat to transfer from the center body to the fuel, thus also pre-heating the fuel prior to it entering the chamber. In this embodiment, the fuel is pre-heated as heat is transferred from the center body 18 (i.e. as the center body 18 is cooled.)

FIG. 2 depicts a further embodiment of the present invention, where the generators 26 on the center body 24 are larger than those shown in FIG. 1. As indicated above, the specific shape, depth, diameter, number and geometric configuration of the generators 26 are to be optimized so as to impart the maximum amount of mixing without inhibiting or otherwise adversely affecting the downstream flow of the fuel-air mixture or DDT.

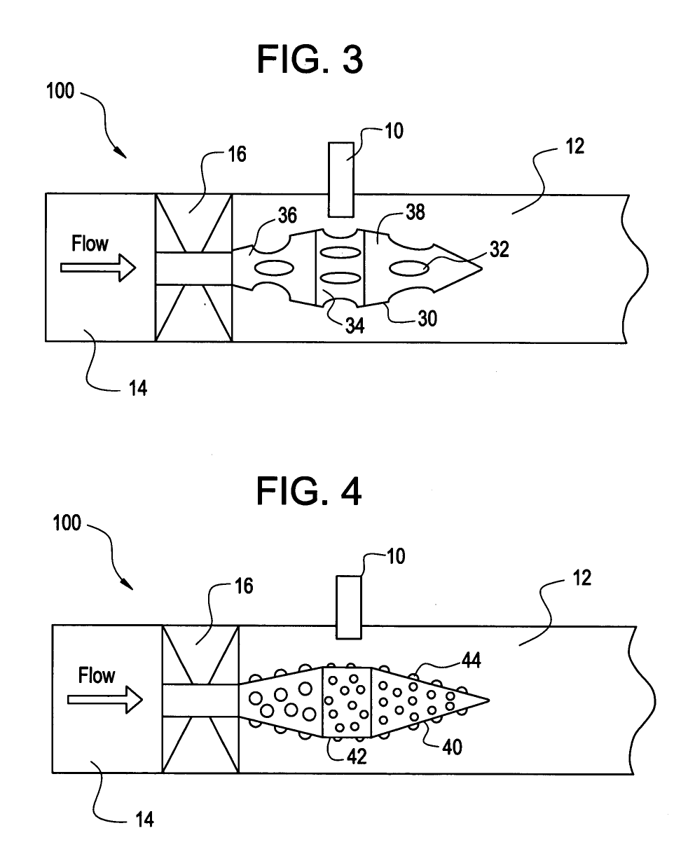

FIG. 3 shows another embodiment of the present invention, where the overall cross-section of the center body 30 varies along the length of the center body 30. In this embodiment, a central region 34 of the center body 30 has a larger cross-sectional area than both an upstream 36 and downstream 38 portion of the center body 30. Further, as shown in this embodiment, the center body contains a number of turbulence generators 32. By varying the diameter along the length of the center body 18 the local bulk velocity of the mixture and flow can be tailored to optimize DDT. Thus, the specific cross-sectional size and shape of the center body may be varied by a skilled artisan to achieve the desired performance and operational characteristics.

The embodiment shown in FIG. 4 is similar to that shown in FIG. 3. However, in the FIG. 4 embodiment the generators 44 on the center body 40 are convex. In a further embodiment (not shown), the center body 40 contains a plurality of both convex and concave shaped generators 44. The number, shape and distribution of each of the convex and concave generators are made to maximize mixing of the fuel-air mixture and to minimize the DDT run-up.

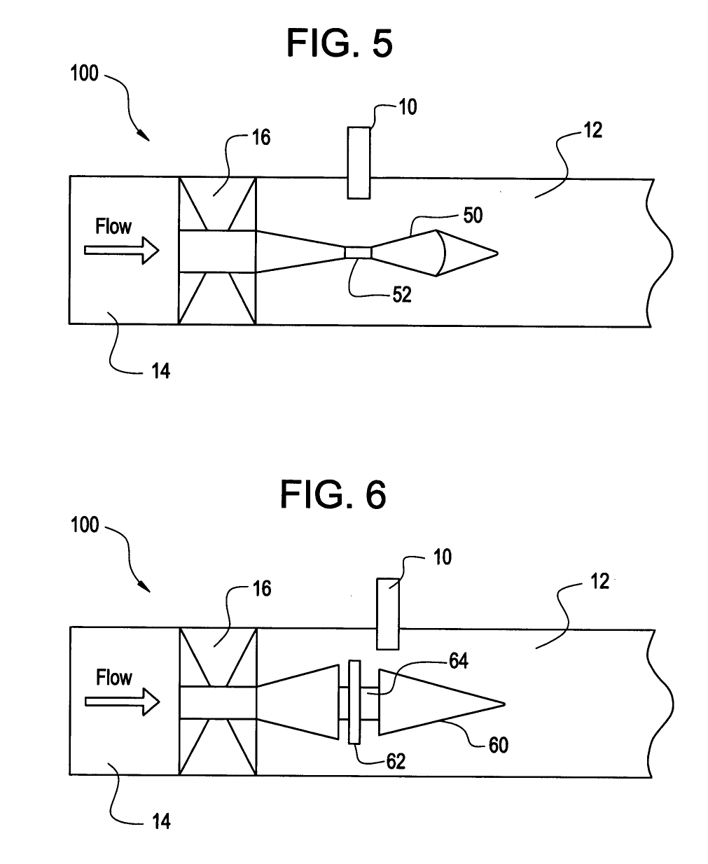

FIG. 5 depicts a further alternative of the present invention, where the center body 50 has a center portion 52 which is smaller in cross-section than upstream and downstream sections. Further, although this embodiment is shown with the center body 50 having no additional turbulence generators (as in FIGS. 1-4), in an additional embodiment, additional turbulence generators can be placed on the surface of the center body 50.

FIG. 6 shows yet another embodiment of the present invention, where a central region of the center body contains an obstacle portion 62 to promote turbulent mixing of the fuel-air mixture. As shown, the obstacle portion 62 has a cross-section, or size, which is larger than the remaining portions of the center body 60. This configuration allows the obstacle 62 to interfere with the flow, thus creating turbulence. The present invention is not limited to the embodiment shown in FIG. 6. For example, it is contemplated that the central portion of the center body 60 contains only a recessed portion 64, and no obstacle portion 62. As with the embodiments discussed above, the exact geometric configuration of the obstacle 62 and recessed portion 64 are optimized to maximize mixing and minimize flame holding. In a further embodiment, the obstacle portion 62 is positioned upstream of the ignition source.

In each of FIGS. 1 through 6, a single center body is shown coupled co-axially with the mixer 16 of the pulse detonation combustor 100. However, the present invention is not limited to this embodiment. Specifically, an alternative embodiment may contain a plurality of center bodies extending downstream from the mixer 16, where the center bodies are positioned symmetrically and radially with respect to a centerline of the mixer. For example, an embodiment may contain three center bodies which are centered in a triangular configuration with respect to the exit face of the mixer 16.

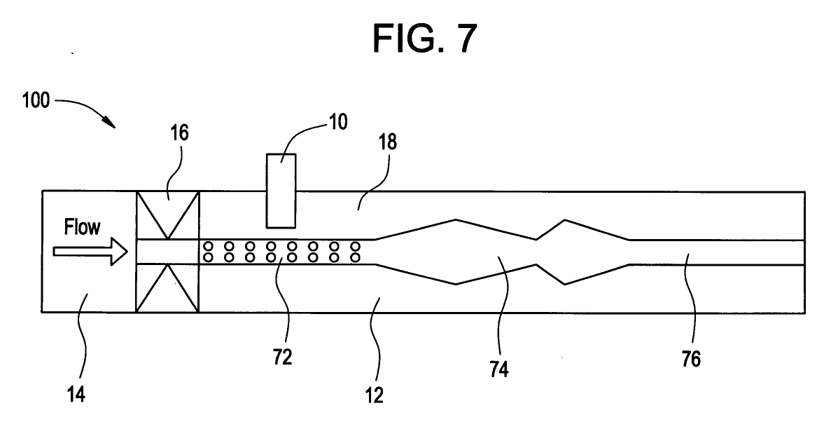

Further, in each of the FIGS. 1 through 6, the center body 18 is shown to be shorter in length than the chamber 12. However, in an alternative embodiment, the center body 18 may extend the entire length of the chamber 12, or beyond. An embodiment of this aspect of the present invention is shown in FIG. 7. In this embodiment, the upstream most portion 72 of the center body 18 is used as described above, to enhance mixing. A central portion 74 is shaped and configured to optimize shock reflections, from the detonation process, and focus the shock reflections to enhance hot spot formation within the detonation. The downstream portion 76 is configured to facilitate detonation propagation along the length of the chamber 12. The physical characteristics of the central and downstream portions are determined to optimize the desired performance characteristics. Furthermore, as the cross-sectional area of the detonation chamber decreases due to the presence of the center body, the bulk velocity of the flow during the fuel fill and the purge processes of the PDC cycle increases, thereby decreasing the fuel fill time and the purge time. As the cycle time decreases (due to decreasing fill time and purge time), the frequency of the PDC cycle operation increases, which in turn increases the performance of the PDC. In an additional embodiment, the use of nozzles 28 along a longer length than just the upstream portion 72 would allow for shorter fill times for the chamber 12.

Although the above discussion has been primarily directed to the use of the present invention in conjunction with aircraft engines, those of ordinary skill in the art will recognize that the present invention may be used with any device using pulse detonation combustors, where it is desirable to reduce the size of the pulse detonation combustor. The present invention may also be used with other components and geometries which are used to further enhance DDT. For example, the present invention may be coupled with swirlers, obstacles, etc., which may extend from the chamber walls or from the mixer, while still maintaining the scope and spirit of the invention.

Further, while the invention has been described in terms of various specific embodiments, those skilled in the art will recognize that the invention can be practiced with modification within the spirit and scope of the claims.

What is claimed is:

1. A pulse detonation combustor; comprising:
a fuel-air mixer from which a mixture of fuel and air exits into a detonation chamber;
an ignition source coupled to said chamber to ignite said fuel-air mixture; and
at least one center body extending from said fuel-air mixer into said chamber,
wherein said center body has at least one turbulence generator on a surface of said center body.

2. The pulse detonation combustor of claim 1, wherein said center body has a plurality of said turbulence generators on said surface.

3. The pulse detonation combustor of claim 1, wherein said center body is positioned coaxially with said mixer.

4. The pulse detonation combustor of claim 1, wherein said turbulence generator has either a concave or convex shape, with respect to said surface.

5. The pulse detonation combustor of claim 2, wherein at least some of said generators have a convex or concave shape with respect to said surface.

6. The pulse detonation combustor of claim 1, wherein said ignition source is positioned downstream of said mixer, and adjacent to said center body.

7. The pulse detonation combustor of claim 1, wherein said ignition source is located at a distance either 2D downstream from said mixer, where D is a diameter of said detonation chamber, or corresponding to a midpoint of said center body along a length of said center body.

8. The pulse detonation combustor of claim 1, wherein said center body comprises at least one nozzle through which at least one of fuel, air and an additional fuel-air mixture passes to enter said chamber.

9. The pulse detonation combustor of claim 1, wherein said center body comprises a central portion which has a cross-sectional area which is larger than a cross-sectional area of both an upstream portion and a downstream portion.

10. The pulse detonation combustor of claim 1, wherein said center body comprises a central portion which has a cross-sectional area which is smaller than a cross-sectional area of both an upstream portion and a downstream portion.

11. The pulse detonation combustor of claim 2, wherein said plurality of turbulence generators are divided into a plurality of groups, where a first group of turbulence generators has at least one geometric characteristic which is different from the remaining turbulence generators.

12. The pulse detonation combustor of claim 1, wherein said ignition source is coupled to said center body.

13. The pulse detonation combustor of claim 1, further comprising at least one additional ignition source.

14. The pulse detonation combustor of claim 13, wherein at least one of said ignition source and said at least one additional ignition source is coupled to said center body.

15. The pulse detonation combustor of claim 1, further comprising a plurality of center bodies extending from said fuel air mixer.

16. The pulse detonation combustor of claim 15, wherein said plurality of pulse detonation are positioned symmetrically with respect to said fuel air mixer.

17. The pulse detonation combustor of claim 1, wherein the center body extends the entire length of said chamber, and said at least one turbulence generator is positioned on an upstream section of said center body.

18. The pulse detonation combustor of claim 1, wherein said center body comprises a central portion which has a cross-sectional area which is larger than a cross-sectional area of at least one of an upstream portion and a downstream portion.

19. The pulse detonation combustor of claim 1, wherein said center body comprises a central portion which has a cross-sectional area which is smaller than a cross-sectional area of at least one of an upstream portion and a downstream portion.

20. A pulse detonation combustor; comprising:
a fuel-air mixer from which a mixture of fuel and air exits into a detonation chamber;
an ignition source coupled to said chamber to ignite said fuel-air mixture; and
at least one center body extending along a length of said chamber downstream of said fuel-air mixer into said chamber,
wherein said center body has at least one turbulence generator on a surface of said center body.
